(19) United States
(12) Patent Application Publication
(10) Pub. No.: US 2026/0001590 A1
(43) Pub. Date: Jan. 1, 2026

(54) FRAME INTERNAL TUBE BULKHEAD

(71) Applicant: Ford Global Technologies, LLC, Dearborn, MI (US)

(72) Inventors: Mikolaj Tyksinski, Madison, WI (US); Benjamin Mansfield, Battle Creek, MI (US); Tushar B. Kamble, Canton, MI (US); Scott J. Bell, Northville, MI (US); Jeffrey A. Walesch, Canton, MI (US); Sankarsh Kanth Aekbote, Farmington, MI (US); Leonard Anthony Shaner, New Baltimore, MI (US); Ryan Craig, Novi, MI (US)

(21) Appl. No.: 18/758,855

(22) Filed: Jun. 28, 2024

(51) Int. Cl. B62D 21/15; B62D 21/03

(52) U.S. Cl. CPC B62D 21/152; B62D 21/03

(57) ABSTRACT

A structural support assembly for a vehicle, the structural support assembly comprising a longitudinal frame member that extends parallel to a longitudinal centerline of the vehicle and has an inner rail wall and an outer rail wall, a cross-member operably coupled to the longitudinal frame member and extending substantially perpendicular to the longitudinal centerline, and an internal frame reinforcement member only operably coupled to the inner rail wall of the longitudinal frame member. The internal frame reinforcement member may be disposed proximate to an intersection of the cross-member and the longitudinal frame member.

### TECHNICAL FIELD

Example embodiments generally relate to vehicle frame architecture and, more particularly, relate to a tube bulkhead that may be provided internal to a frame member to enhance performance in frontal and offset barrier event response.

### BACKGROUND

In a typical frontal barrier event, adding welded internal structure to the frame shunts deformable retraction space required for pulse management thereby reducing performance and increasing pulse. Internal frame reinforcements are, on the other hand, helpful in supporting a robust lateral load path for offset barrier events. Thus, some balance of these competing interests may be desirable.

### BRIEF SUMMARY OF SOME EXAMPLES

In accordance with an example embodiment, a structural support assembly for a vehicle may be provided. The structural support assembly may include a longitudinal frame member that extends parallel to a longitudinal centerline of the vehicle and has an inner rail wall and an outer rail wall, a cross-member operably coupled to the longitudinal frame member and extending substantially perpendicular to the longitudinal centerline, and an internal frame reinforcement member only operably coupled to the inner rail wall of the longitudinal frame member. The internal frame reinforcement member may be disposed proximate to an intersection of the cross-member and the longitudinal frame member.

In another example embodiment, a vehicle frame for a body on frame vehicle may be provided. The vehicle frame may include a first longitudinally extending frame member spaced laterally from a longitudinal centerline of the body on frame vehicle, a second longitudinally extending frame member spaced laterally from the longitudinal centerline on an opposite side of the longitudinal centerline relative to the first longitudinal frame member, and a cross-member operably coupling the first and second longitudinal frame members and extending substantially perpendicular to the longitudinal centerline. Each of the first and second longitudinal frame members may include a respective instance of an inner rail wall closest to the longitudinal centerline and an outer rail wall farther away from the longitudinal centerline. Each of the first and second longitudinal frame members may also include an internal frame reinforcement member that is only operably coupled to the inner rail wall proximate to an intersection of the cross-member and a respective one of the first and second longitudinal frame members.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a partially isolated top view of a frame assembly of a vehicle in accordance with an example embodiment;

FIG. 2 illustrates a perspective view of one side of the frame assembly (i.e., one structural support assembly) in accordance with an example embodiment;

FIG. 3 illustrates a top view of a tube bulkhead within a longitudinal frame member with a top wall thereof removed to illustrate placement of the tube bulkhead relative to inner and outer rail walls of the longitudinal frame member in accordance with an example embodiment; and

FIG. 4 illustrates a cross section view of the structural support assembly in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As noted above, a balance may be desirable between performance attributes of frame assembly reinforcement in response to frontal and offset barrier events. Example embodiments may provide internal lateral reinforcement that is partially decoupled from the inner frame, while being strategically located for energy management. In this regard, for example, providing a tube bulkhead that is only welded to one side of a longitudinal frame member may provide for engagement of offset reinforcement structure laterally across the vehicle for an offset barrier event while also limiting any reduction in deformable retraction space for a frontal barrier event. The tube bulkhead used to provide internal reinforcement for example embodiments may provide a robust lateral load path in an offset barrier event from an outboard structural outrigger (or deflector/deflection arm), by being located proximate to a frame cross-member. Moreover, use of a tube bulkhead may also limit the longitudinal footprint of the reinforcement, thereby allowing for increased deformable retraction length in response to a frontal barrier event, while providing a stress consolidator to trigger additional deformable retraction.

As used herein, the term “deformable retraction” refers to the reduction in length of a structural member as the structural member deforms in response to a force or load that exceeds the maximum compressive stress that a solid structure can sustain without structural compromise (i.e., when the material's compressive strength is exceeded). The deformable retraction (or deformable compression), which is a familiar phenomenon associated with, for example, placing one's full weight on an aluminum soda can, is a useful absorber of energy in response to barrier events involving other vehicles or objects. Accordingly, management and strategic use of deformable retraction can be valuable for managing the pulse that may be experienced by occupants of a vehicle when a barrier event occurs. Example embodiments provide a tube bulkhead that is both attached to the longitudinal frame member in a strategic way, and at a strategic location, in order to maximally balance the energy management performance of the longitudinal frame member in response to frontal and offset barrier events.

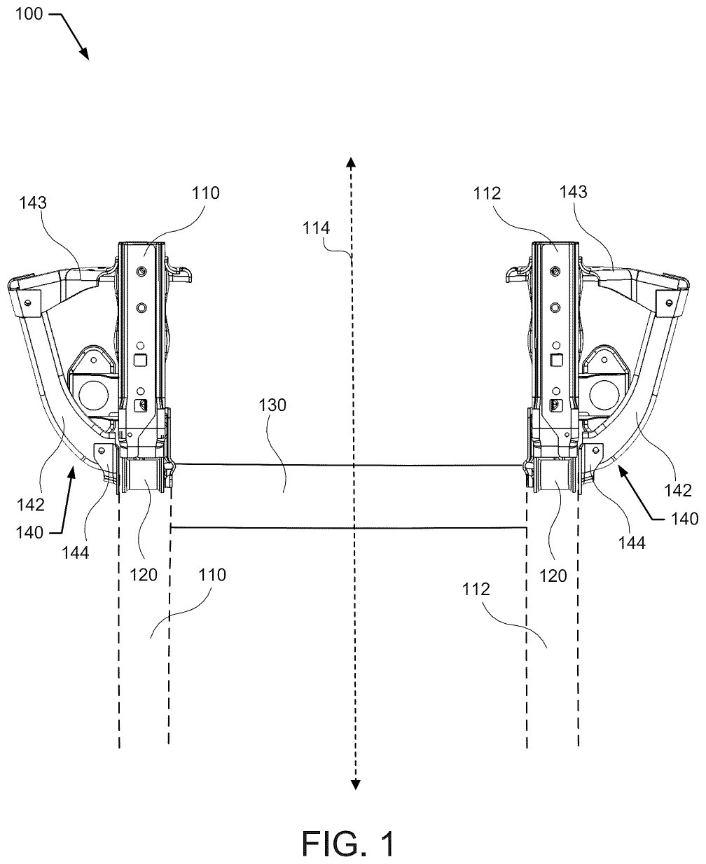

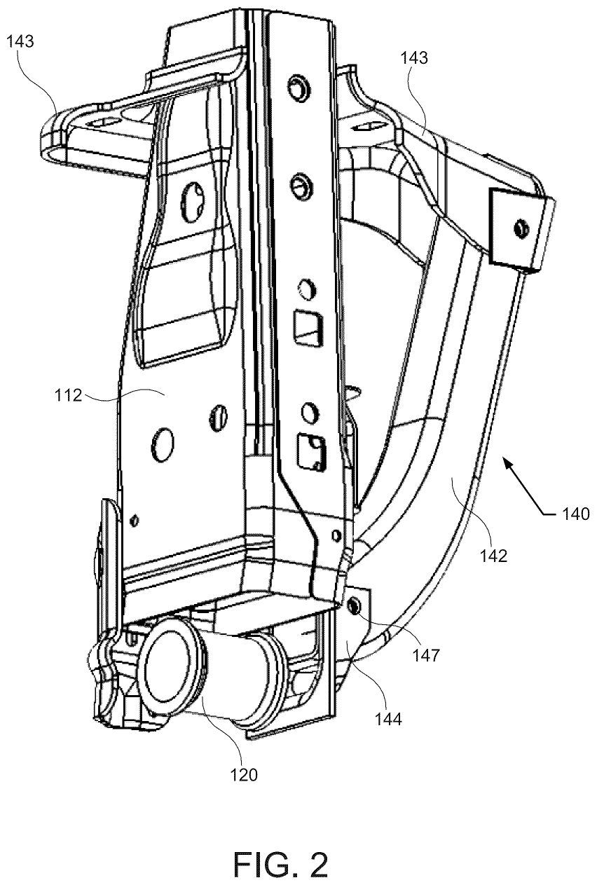

FIG. 1 illustrates a partially isolated top view of a frame assembly 100 of an example embodiment, which may be employed on a vehicle having a body on frame construction, whereas FIG. 2 focuses on just one side of the frame assembly 100. The frame assembly 100 includes a first longitudinal frame member 110 and a second longitudinal frame member 112, which may each extend substantially parallel to, and equally spaced apart from, a longitudinal centerline 114 of the vehicle. The first and second longitudinal frame members 110 and 112 may therefore be understood to correspond to left and right frame members (or vice versa). Each of the first and second longitudinal frame members 110 and 112 may be formed from an elongated hollow metallic structure (or tube). In some cases, the first and second longitudinal frame members 110 and 112 may further by structured to have a substantially rectangular cross sectional shape. Thus, for example, the first and second longitudinal frame members 110 and 112 may each have a substantially rectangular inner rail wall 111 that faces a substantially rectangular outer rail wall 113 and are connected at their respective tops and bottoms (relative to the ground) by substantially rectangular top and bottom rail walls to bound a hollow space inside the first and second longitudinal frame members 110 and 112, respectively. The first and second longitudinal frame members 110 and 112 may each also have slight bends and changes in width or height at various locations along their lengths, but may generally mirror each other about the longitudinal centerline 114.

In FIGS. 1 and 2, a portion of each of the first and second longitudinal frame members 110 and 112 is removed to provide visual access to the hollow interior of the first and second longitudinal frame members 110 and 112 at a location at which a tube bulkhead 120 is provided for reinforcement. Removed portions of the first and second longitudinal frame members 110 and 112 rearward of the tube bulkhead 120 are shown in dashed lines in FIG. 1. Moreover, the tube bulkhead 120 is also disposed at a portion of each of the first and second longitudinal frame members 110 and 112 that is proximate a cross-member 130, which provides lateral reinforcement by extending between the first and second longitudinal frame members 110 and 112. The tube bulkhead 120 of this example may have a substantially cylindrically shaped core, which may be hollow in some cases. Moreover, the tube bulkhead 120 may have flared longitudinal ends that define a spool shape in some cases. However, other shapes and structures may be employed in alternative embodiments.

The frame assembly 100 may also include two separate instances (i.e., one on each side of the vehicle) of a deflector assembly 140. The deflector assembly 140 may include a deflector arm 142 that has a curved or arcuate shape that extends away from a respective one of the first and second longitudinal frame members 110 and 112. Each instance of the deflector assembly 140 may include two interface portions that operably couple opposing ends of the deflector arm 142 of the deflector assembly 140 to a respective one of the first and second longitudinal frame members 110 and 112. In this regard, a first interface disposed at a distal or front end of the corresponding one of the first and second longitudinal frame members 110 and 112 may be embodied as a sliding interface. The sliding interface may include a sliding bracket 143 that is operably coupled to a distal end of the deflector arm 142 and bends inwardly to extend around the outer walls of the corresponding one of the first and second longitudinal frame members 110 and 112 at or near the front (or distal) end of the corresponding one of the first and second longitudinal frame members 110 and 112.

A second interface may be a fixed interface at a proximal end of the deflector arm 142 that operably couples the deflector arm 142 to an outer side (e.g., the outer rail wall 113) of the corresponding one of the first and second longitudinal frame members 110 and 112. In some cases, the fixed interface may be provided by a coupling bracket 144 that is affixed to the outer rail wall 113 of the corresponding one of the first and second longitudinal frame members 110 and 112. Each respective instance of the deflector assembly 140 may therefore be understood to extend away from the corresponding one of the first and second longitudinal frame members 110 and 112, outwardly, and in a direction that presents the deflector assembly 140 to initially absorb any energy exerted responsive to an offset barrier event, whereas the first and second longitudinal frame members 110 and 112 typically initially absorb any energy exerted responsive to a frontal barrier event.

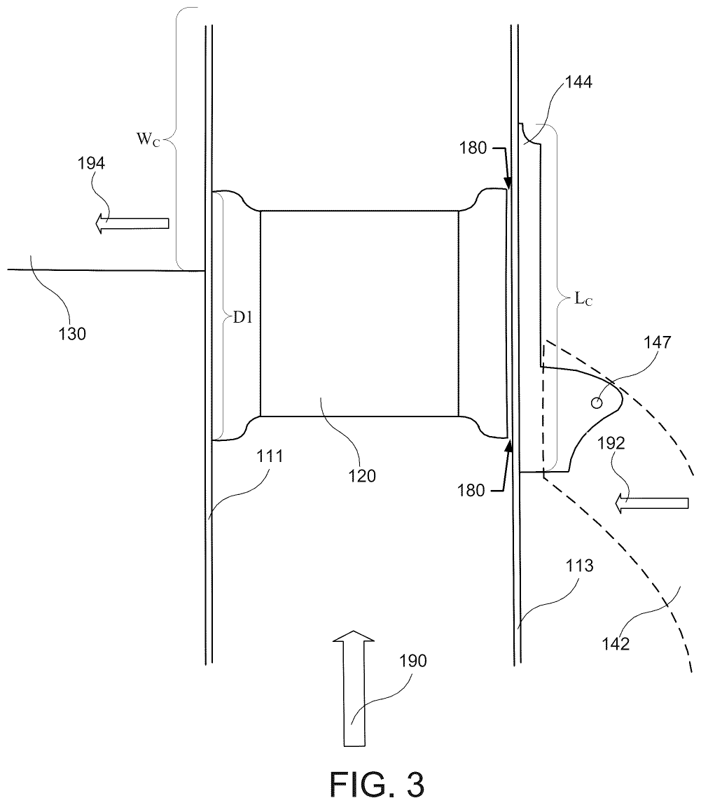

The coupling bracket 144 may be operably coupled to the deflector arm 142 and the outer surface of the outer side of the corresponding one of the first and second longitudinal frame members 110 and 112 via any suitable means. For example, one or more instances of a weld joint, a bolt or other fastener, a shear pin, or the like, may operably couple the coupling bracket 144 to the deflector arm 142 and the outer surface of the outer rail wall 113 of the corresponding one of the first and second longitudinal frame members 110 and 112. In an example embodiment, the coupling bracket 144 may be attached to the corresponding one of the first and second longitudinal frame members 110 and 112 and/or the deflector arm 142 via a shear pin 147 (see FIG. 3) or other physical connection that is designed to shear or break at or near a predetermined force level, which may be encountered in connection with an offset barrier event. In some cases, the coupling bracket 144 may be attached to the corresponding one of the first and second longitudinal frame members 110 and 112, and the shear pin 147 may attach the coupling bracket 144 to the deflector arm 142, as shown in FIG. 3. Notably, after the shear pin 147 breaks responsive to force application, the deflector arm 142 may also slide along the first or second longitudinal frame member 110 or 112 to further provide for deformable retraction and energy absorption.

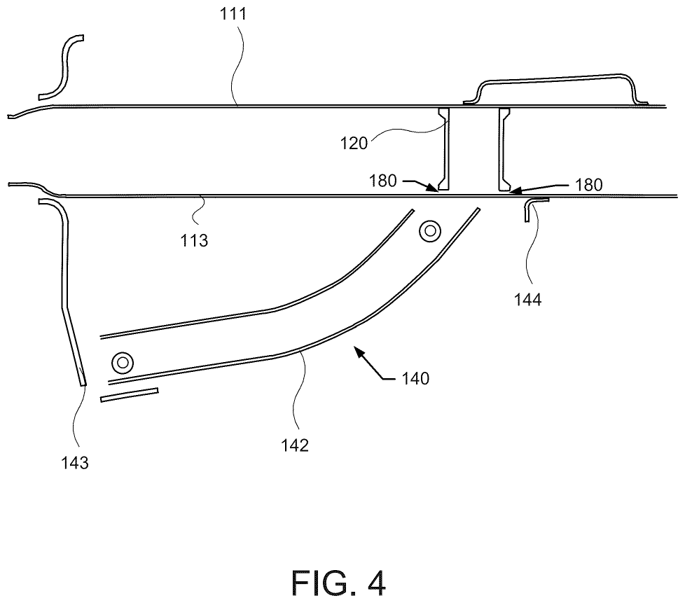

FIG. 3 illustrates a top down view of the tube bulkhead 120 inside the second longitudinal frame member 112 with the top rail wall removed to expose the tube bulkhead 120. FIG. 3 also allows clear visibility of how the tube bulkhead 120 interfaces with the inner rail wall 111 and is positioned relative to the coupling bracket 144 and the cross-member 130. FIG. 4 illustrates a cross sectional view (from above and looking downward) of the first longitudinal frame member 110, which also shows the relationships mentioned above in reference to FIG. 3. Referring now to FIGS. 1-4, it is notable that in some embodiments, the coupling bracket 144 may have a longitudinal length (i.e., a length substantially parallel to the longitudinal centerline 114) that overlaps with the tube bulkhead 120. In this regard, for example a length (L_{C}) of the coupling bracket 144 is longer than a diameter (D1) of the tube bulkhead 120, and may entirely overlap the diameter (D1) of the tube bulkhead 120 on the outside of the outer rail wall 113. Meanwhile, a width (W_{C}) of the cross-member 130 may only partially overlap the diameter (D1) of the tube bulkhead 120. Moreover, in some cases, the width (W_{C}) of the cross-member 130 may be substantially wider than the diameter (D1) of the tube bulkhead 120, but the overlap of the width (W_{C}) of the cross-member 130 and the tube bulkhead 120 across the inner rail wall 111 may occur over less than half of the diameter (D1) of the tube bulkhead 120.

During a frontal barrier event, it may be desirable to maximize the length of the first and second longitudinal frame members 110 and 112 that is available for deformable retraction since all of the length that deformably retracts absorbs energy from the barrier event that is not passed on to any occupant. Meanwhile, if the tube bulkhead 120, which is an example of an internal frame reinforcement member, is affixed to an inner surface of either the inner rail wall 111 or the outer rail wall 113, the corresponding portion of the inner rail wall 111 or outer rail wall 113 that is reinforced by being affixed to the tube bulkhead 120 may not be capable of deformable retraction. However, if only one side (e.g., the inner rail wall 111) of the tube bulkhead 120 is affixed, then the other side (e.g., the outer rail wall 113) remains capable of deformable retraction and thereby also increases energy absorption.

In an example embodiment, the tube bulkhead 120 may actually be spaced apart from the outer rail wall 113 to ensure that the outer rail wall 113 in this region remains capable of deformable retraction and corresponding energy absorption. The space therebetween may be provide by a gap 180. The gap 180 may be small and, in some cases, may be between about 5 mm, although any length for the gap 180 in the range of about 0.1 mm to about 10 mm in length may alternatively be employed.

In some cases, by providing the relative placement noted above (e.g., with overlap of both the cross-member 130 and the coupling bracket 144 relative to the diameter of the tube bulkhead 120), further advantageous energy absorption can be provided for cross car stiffness since the deflector assembly 140 may, when contacted during an offset barrier event, transfer energy to the tube bulkhead 120. The transfer of energy to the tube bulkhead 120 may initially occur via energy imparted on the deflector arm 142 and the coupling bracket 144 being passed on to the outer rail wall 113 to close the gap 180 and initiate contact with the tube bulkhead 120. Energy imparted on the tube bulkhead 120 may then be communicated to the cross-member 130 and deformable retraction of the cross-member 130 may be facilitated to further absorb energy and manage energy dissipation.

Thus, the gap 180 in combination with the relative positioning described above provides at least a dual benefit for the frame assembly 100. In this regard, a first benefit may include increasing the amount of the first or second longitudinal frame member 110 or 112 that remains capable of deformable retraction by forgoing reinforcement of the outer rail wall 113 (due to only being attached to the inner rail wall 111) for a frontal barrier event providing a compressive force in the direction of arrow 190 in FIG. 3. The attachment of the tube bulkhead 120 to only the inner rail wall 111 therefore enables substantially all of the outer rail wall 113 (particularly in the region of the tube bulkhead 120) to be deformably retracted, and substantially all of the inner rail wall 111 except that small portion affixed to the tube bulkhead 120 (and therefore having a length about equal to the diameter (D1) of the tube bulkhead 120) available for deformable retraction and its attendant energy absorption.

A second benefit is provided since the gap 180 also provides only a small space that must be removed during an offset barrier event in order to engage the deflector arm 142 to the tube bulkhead 120 for energy transfer to the cross-member 130. In this regard, responsive to a compressive force in a direction of arrow 192 from an offset barrier event, the deflector arm 142 may apply a force onto the outer rail wall 113 to close the gap 180 while also absorbing energy due to its own deformable retraction. The force on the outer rail wall 113 may then be transferred through the tube bulkhead 120 and the inner rail wall 111 to the cross-member 130, which may deformably retract in a direction of arrow 194 to further absorb energy. Thus, the placement and attachment of the tube bulkhead 120 relative to the cross-member 130 and the deflector arm 142 may provide superior energy management in response to any barrier event.

A structural support assembly for a vehicle may therefore be provided. The structural support assembly may include a longitudinal frame member that extends parallel to a longitudinal centerline of the vehicle and has an inner rail wall and an outer rail wall, a cross-member operably coupled to the longitudinal frame member and extending substantially perpendicular to the longitudinal centerline, and an internal frame reinforcement member only operably coupled to the inner rail wall of the longitudinal frame member. The internal frame reinforcement member may be disposed proximate to an intersection of the cross-member and the longitudinal frame member.

The structural support assembly (or a vehicle frame for a body on frame vehicle having such a structural support assembly) of some embodiments may include additional features, modifications, augmentations and/or the like to achieve further objectives or enhance performance of the assembly. The additional features, modifications, augmentations and/or the like may be added in any combination with each other. Below is a list of various additional features, modifications, and augmentations that can each be added individually or in any combination with each other. For example, the internal frame reinforcement member may be disposed spaced apart from the outer rail wall to form a gap between the internal frame reinforcement member and the outer rail wall. In an example embodiment, the gap may be between about 0.1 mm and 10 mm. In some cases, the structural support assembly may further include a deflector assembly extending away from the outer rail wall relative to the longitudinal centerline. The deflector assembly may include a first interface with a front portion of the longitudinal frame member and a second interface with a portion of the longitudinal frame member proximate to the internal frame reinforcement member. In an example embodiment, the first interface may include a sliding interface and the second interface may include a coupling bracket operably coupled to the outer rail wall. The coupling bracket may extend beyond both longitudinal ends of a diameter of the internal frame reinforcement member. In some cases, a width of the cross-member may extend over an outer surface of the inner rail wall to overlap with less than half the diameter of the internal frame reinforcement member. In an example embodiment, the deflector assembly may include an elongate member having an arcuate shape extending away from the longitudinal centerline from the second interface to the first interface. In some cases, a shear pin may operably couple the elongate member to an outer surface of the outer rail wall at the second interface. In some cases, the internal frame reinforcement member may be embodied as a tube bulkhead having a substantially cylindrically shaped core.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed:

1. A structural support assembly for a vehicle, the structural support assembly comprising:
a longitudinal frame member that extends parallel to a longitudinal centerline of the vehicle and has an inner rail wall and an outer rail wall;
a cross-member operably coupled to the longitudinal frame member and extending substantially perpendicular to the longitudinal centerline; and
an internal frame reinforcement member only operably coupled to the inner rail wall of the longitudinal frame member,
wherein the internal frame reinforcement member is disposed proximate to an intersection of the cross-member and the longitudinal frame member.

2. The structural support assembly of claim 1, wherein the internal frame reinforcement member is disposed spaced apart from the outer rail wall to form a gap between the internal frame reinforcement member and the outer rail wall.

3. The structural support assembly of claim 2, wherein the gap is between about 0.1 mm and 10 mm.

4. The structural support assembly of claim 1, further comprising a deflector assembly extending away from the outer rail wall relative to the longitudinal centerline,
wherein the deflector assembly includes a first interface with a front portion of the longitudinal frame member and a second interface with a portion of the longitudinal frame member proximate to the internal frame reinforcement member.

5. The structural support assembly of claim 4, wherein the first interface comprises a sliding interface.

6. The structural support assembly of claim 4, wherein the second interface comprises a coupling bracket operably coupled to the outer rail, and
wherein the coupling bracket extends beyond both longitudinal ends of a diameter of the internal frame reinforcement member.

7. The structural support assembly of claim 6, wherein a width of the cross-member extends over an outer surface of the inner rail wall to overlap with less than half the diameter of the internal frame reinforcement member.

8. The structural support assembly of claim 4, wherein the deflector assembly comprises an elongate member having an arcuate shape extending away from the longitudinal centerline from the second interface to the first interface.

9. The structural support assembly of claim 8, wherein a shear pin operably couples the elongate member to an outer surface of the outer rail at the second interface.

10. The structural support assembly of claim 1, wherein the internal frame reinforcement member comprises a tube bulkhead having a substantially cylindrically shaped core.

11. A vehicle frame for a body on frame vehicle, the vehicle frame comprising:
a first longitudinally extending frame member spaced laterally from a longitudinal centerline of the body on frame vehicle;
a second longitudinally extending frame member spaced laterally from the longitudinal centerline on an opposite side of the longitudinal centerline relative to the first longitudinal frame member; and
a cross-member operably coupling the first and second longitudinal frame members and extending substantially perpendicular to the longitudinal centerline,
wherein each of the first and second longitudinal frame members includes a respective instance of an inner rail wall closest to the longitudinal centerline and an outer rail wall farther away from the longitudinal centerline,
wherein each of the first and second longitudinal frame members further includes an internal frame reinforcement member only operably coupled to the inner rail proximate to an intersection of the cross-member and a respective one of the first and second longitudinal frame members.

12. The vehicle frame of claim 11, wherein the internal frame reinforcement member is disposed spaced apart from the outer rail wall to form a gap between the internal frame reinforcement member and the outer rail.

13. The vehicle frame of claim 12, wherein the gap is between about 0.1 mm and 10 mm.

14. The vehicle frame of claim 11, further comprising a deflector assembly extending away from the outer rail wall relative to the longitudinal centerline,
wherein the deflector assembly includes a first interface with a front portion of the respective one of the first and second longitudinal frame members and a second interface with a portion of the respective one of the first and second longitudinal frame members proximate to the internal frame reinforcement member.

15. The vehicle frame of claim 14, wherein the first interface comprises a sliding interface.

16. The vehicle frame of claim 14, wherein the second interface comprises a coupling bracket operably coupled to the outer rail, and
wherein the coupling bracket extends beyond both longitudinal ends of a diameter of the internal frame reinforcement member.

17. The vehicle frame of claim 16, wherein a width of the cross-member extends over an outer surface of the inner rail wall to longitudinally overlap with less than half the diameter of the internal frame reinforcement member.

18. The vehicle frame of claim 14, wherein the deflector assembly comprises an elongate member having an arcuate shape extending away from the longitudinal centerline from the second interface to the first interface.

19. The vehicle frame of claim 18, wherein a shear pin operably couples the elongate member to an outer surface of the outer rail wall at the second interface.

20. The vehicle frame of claim 11, wherein the internal frame reinforcement member comprises a tube bulkhead having a substantially cylindrically shaped core.
